(19) United States
(12) Patent Application Publication
(10) Pub. No.: US 2022/0404734 A1
(43) Pub. Date: Dec. 22, 2022

(54) IMAGE FORMING DEVICE

(71) Applicant: KYOCERA Document Solution Inc., Osaka-shi (JP)

(72) Inventors: Takahisa NAKAUE, Osaka-shi (JP); Kotatsu KAWAGUCHI, Osaka-shi (JP); Masahito ISHINO, Osaka-shi (JP); Yukari OTA, Osaka-shi (JP); Tomohiro TAMAKI, Osaka-shi (JP); Minoru WADA, Osaka-shi (JP)

(21) Appl. No.: 17/764,705

(22) PCT Filed: Jan. 21, 2021
(86) PCT No.: PCT/JP2021/002018

§ 371 Date: Mar. 29, 2022

(30) Foreign Application Priority Data
Feb. 6, 2020 (JP) 2020-018658
Aug. 12, 2020 (JP) 2020-136128

(51) Int. Cl. G03G 15/08

(52) U.S. Cl. CPC G03G 15/0812

(57) ABSTRACT

An image forming device includes photoconductor drum that rotates around axis and has drum circumferential face on which electrostatic latent image is formed, and developing unit that supplies developer to photoconductor drum thereby to manifest electrostatic latent image into developer image. The developing unit includes developing housing, developing roller supported by developing housing to be rotatable around axis, has first circumferential face that faces drum circumferential face and carries developer, and supplies carried developer to drum circumferential face, and restricting blade that contacts first circumferential face, and restricts amount of developer to be carried on first circumferential face, and first circumferential face has value of 4.5% to 10% as actual contact area ratio representing actual contact area relative to apparent contact area with restricting blade, and restricting blade is arranged relative to first circumferential face at contact linear pressure of 10 N/m to 60 N/m at actual contact area ratio.

### TECHNICAL FIELD

The present invention relates to an image forming device of a non-magnetic single-component developing method.

### BACKGROUND ART

A conventional image forming device of a non-magnetic single-component developing method that performs developing by using a non-magnetic single-component developing agent has been known. In the image forming device of the non-magnetic single-component developing method, a toner is conveyed by fine convexity and concavity provided on a developing roller's circumferential face, and any excess toner is scraped off by a restricting blade (e.g., Patent Literature 1). With this, a toner thin layer is formed on the developing roller's circumferential face. Further, the toner that forms the toner thin layer, when passing under the restricting blade, is charged by rubbing with the restricting blade. Then, the toner on the developing roller's circumferential face moves to a photoconductor due to an electric field formed between the developing roller and the photoconductor, thereby to develop an electrostatic latent image formed on the photoconductor.

When performing the developing with a two-component developing agent containing toner and carrier, devices such as magnets, metal sleeves, and carriers are required. However, when the developing using a non-magnetic single-component developing agent is performed, these devices are not necessary, and merely applying a DC component bias to the developing roller can perform the developing. Since being configured simply and at low cost, the image forming device of the non-magnetic single-component developing method is mainly used for a low-speed compact machine.

However, in the image forming device of the non-magnetic single-component developing method, as shown in FIG. 11, when a thickness of the toner layer formed on a developing roller 331's circumferential face is restricted by a restricting blade 334, a strong stress is applied to the toner, which may cause a sticking matter 99 of the toner to a part of the restricting blade 334 (fused matter).

When the toner sticks to the restricting blade, it is not possible to form a toner layer of uniform thickness on the developing roller's circumferential face, resulting in a phenomenon called a thin layer streak in which the toner layer becomes locally thin on the developing roller's circumferential face. When the thin layer streak should occur, an electrostatic latent image formed on the photoconductor is not properly developed, and a white streak may be seen in the image formed on the sheet. Using a so-called soft toner, which can be fixed to the sheet at a low temperature, so as to save energy, makes the toner tend to stick to the restricting blade, causing the thin layer streak to be more notable.

Therefore, an art has been proposed so as to reduce the stress applied to the toner by the restricting blade. For example, it has been proposed to attach an elastic member to the restricting blade (e.g., Patent Literature 2).

### CITATION LIST

### Patent Literature

PTL 1: Japanese Patent No. 6376688
PTL 2: Japanese Unexamined Patent Application Laid-Open No. 10-332714

### SUMMARY OF THE INVENTION

### Problems to be Solved by the Invention

However, although reducing the stress applied to the toner, the Patent Literature 2 does not consider an area where the developing roller's circumferential face and an elastic member come into contact with each other. When the contact area is too small, the stress applied to the toner may be reduced too much, and the toner layer formed on the developing roller's circumferential face may become too thick and the charge amount of the toner forming the toner layer may become too low. Meanwhile, when the contact area is too large, the toner to which the strong stress is applied by the elastic member cannot flow to a non-contact area, and the toner may stick to the elastic member too much. In these cases, the electrostatic latent image formed on the photoconductor's circumferential face may not be properly developed, which may cause a problem to the image finally formed on the sheet.

For solving the above problem, the present invention has been made; and it is an object of the present invention to provide an image forming device of a non-magnetic single-component developing method which can reduce the developing agent's sticking to a restricting blade and can properly develop an electrostatic latent image.

### Means for Solving the Problem

An image forming device according to one mode of the present invention, that performs developing using a non-magnetic single-component developing agent, includes a photoconductor drum that rotates around an axis and has a drum circumferential face on which an electrostatic latent image is formed, and a developing unit that supplies the developing agent to the photoconductor drum thereby to manifest the electrostatic latent image into a developing agent image, wherein the developing unit includes a developing housing that houses the developing agent, a developing roller that is supported by the developing housing in a manner to be rotatable around an axis, has a first circumferential face that faces the drum circumferential face and carries the developing agent, and supplies the carried developing agent to the drum circumferential face, and a restricting blade that contacts the first circumferential face, and restricts an amount of the developing agent to be carried on the first circumferential face, and an actual contact area ratio of the first circumferential face is 4.5% or more to 10% or less. Further, the restricting blade has a fixed end portion fixed to the developing housing and a free end portion disposed on an opposite side of the fixed end portion and contacts the first circumferential face of the developing roller, and the free end portion includes a bent portion having a bent shape that is away from the developing roller, and the bent portion has a curvature radius of 0.1 mm or more when viewed from the axial direction of the developing roller; the restricting blade contacts the developing roller in an area including at least a part of the bent portion, and a surface roughness Ra of the area is included in a range of 0.05 μm or more to 0.3 μm or less.

In the present configuration, the surface roughness Ra of the restricting blade's area that includes at least a part of the bent portion and contacts the developing roller is included in the range of 0.05 μm or more to 0.3 μm or less. The actual contact area ratio of the first circumferential face is included in the range of 4.5% or more to 10% or less, and the area of the non-contact portion between the first circumferential face and the restricting blade is greater than in the case where the actual contact area ratio of the first circumferential face is more than 10%. Due to this, when the amount of the developing agent to be carried on the first circumferential face is restricted by the restricting blade, the present configuration allows the developing agent, to which a strong stress is applied by the restricting blade, to be moved to the non-contact portion more easily than in the case where the actual contact area ratio of the first circumferential face is more than 10%. With this, the present configuration can reduce the possibility of the developing agent sticking to the restricting blade more than in the case where the actual contact area ratio of the first circumferential face is more than 10%.

Meanwhile, in the present configuration, the actual contact area ratio of the first circumferential face is included in the range of 4.5% or more to 10% or less, and the area of the non-contact portion between the first circumferential face and the restricting blade is smaller than in the case where the actual contact area ratio of the first circumferential face is less than 4.5%. Due to this, when the amount of the developing agent to be carried on the first circumferential face is restricted by the restricting blade, the present configuration, due to the developing agent moving between nearby non-contact portions, can suppress unevenness from occurring to the thickness of the developing agent layer, more than in the case where the actual contact area ratio of the first circumferential face is less than 4.5%. With this, the present configuration can form the developing agent layer of uniform thickness on the first circumferential face, and can properly develop the electrostatic latent image, more than in the case where the actual contact area ratio of the first circumferential face is less than 4.5%.

Thus, according to the present configuration, the possibility of the developing agent's sticking to the restricting blade can be reduced and the electrostatic latent image can be properly developed, without attaching an elastic member to the restricting blade as conventionally.

In the above configuration, the restricting blade may be supported by the developing housing such that the contact linear pressure against the first circumferential face is included in a range of 10 N/m or more to 60 N/m or less.

In the present configuration, the restricting blade is disposed so that the contact linear pressure against the first circumferential face is 10 N/m or more to 60 N/m or less. Due to this, when the amount of the developing agent to be carried on the first circumferential face is restricted by the restricting blade, the present configuration can apply more proper stress to the developing agent than in the case where the restricting blade's contact linear pressure against the first circumferential face is less than 10 N/m or more than 60 N/m. With this, the present configuration can reduce the possibility of the developing agent sticking to the restricting blade and can form the developing agent layer of uniform thickness on the first circumferential face, and can properly develop the electrostatic latent image, more than in the case where the restricting blade's contact linear pressure against the first circumferential face is less than 10 N/m or more than 60 N/m.

In the above configuration, the developing agent may be manufactured by a pulverizing method.

Compared with the particle of the toner manufactured by a polymerizing method, the particle of the developing agent manufactured by the pulverizing method is less expensive to manufacture, but has lower circularity. Therefore, when a strong stress is applied by the restricting blade, compared with the particle of the developing agent manufactured by the polymerizing method, the particle of the developing agent manufactured by the pulverizing method is more likely to be caught by the restricting blade, and is also more likely to stick due to the mating of concave and convex portions of adjacent particles. Due to this, compared with the developing agent manufactured by the polymerizing method, the developing agent manufactured by the pulverizing method is more likely to stick to the restricting blade, and is more likely to cause an unevenness to the thickness of the developing agent layer formed on the first circumferential face.

However, according to the present configuration, even if the developing agent is manufactured by the pulverizing method, the actual contact area ratio of the first circumferential face is 4.5% or more to 10% or less, as described above, so that when the amount of the developing agent to be carried on the first circumferential face is restricted by the restricting blade, the possibility of the developing agent sticking to the restricting blade can be reduced, and unevenness can be suppressed from occurring to the thickness of the developing agent layer. Due to this, applying, to the image forming device, the developing agent manufactured by the pulverizing method, which agent is less expensive than the developing agent manufactured by the polymerizing method, can reduce the cost of using the image forming device while maintaining the quality of the image finally formed.

In the above configuration, the developing agent's melt viscosity at 90° C. may be included in a range of 10,000 Pa·S or more and 200,000 Pa·S or less.

The developing agent with the melt viscosity of 200,000 Pa·S or less at 90° C. is higher in fluidity than the developing agent with the melt viscosity of more than 200,000 Pa·S at 90° C. In the present configuration, the developing agent's melt viscosity at 90° C. is 200,000 Pa·S or less; therefore, the developing agent, to which a strong stress is applied by the restricting blade, can be caused to flow to the non-contact portion more easily than in the case where the developing agent's melt viscosity at 90° C. is more than 200,000 Pa·S. With this, the present configuration can reduce the possibility of the developing agent's sticking to the restricting blade more than in the case where the developing agent's melt viscosity at 90° C. is more than 200,000 Pa·S.

Meanwhile, the developing agent with the melt viscosity of 10,000 Pa·S or more at 90° C. is lower in fluidity than the developing agent with the melt viscosity of less than 10,000 Pa·S at 90° C. In the present configuration, the developing agent's melt viscosity at 90° C. is 10,000 Pa·S; therefore, when a strong stress is applied to the developing agent by the restricting blade, due to the developing agent moving between the nearby non-contact portions, the unevenness in the thickness of the developing agent layer can be suppressed, more than in the case where the developing agent's melt viscosity at 90° C. is less than 10,000 Pa·S. With this, the present configuration can form the developing agent layer of uniform thickness on the first circumferential face, and can properly develop the electrostatic latent image, more than in the case where the developing agent's melt viscosity at 90° C. is less than 10,000 Pa·S.

### Effect of the Invention

The present invention makes can provide an image forming device of a non-magnetic single-component developing method that can reduce a developing agent's sticking to a restricting blade and can properly develop an electrostatic latent image.

### BRIEF DESCRIPTION OF THE DRAWINGS

FIG. 1 is a cross-sectional view of an internal structure of an image forming device according to one embodiment of the present invention.

FIG. 2 is a cross-sectional view of an image forming unit of the image forming device according to the one embodiment of the present invention.

FIG. 3 is a block diagram showing an electrical configuration of the image forming device.

FIG. 4 is a diagram showing an example of how to calculate an actual contact area ratio.

FIG. 5A is a diagram showing an example of a shot image of a developing roller's circumferential face with the actual contact area ratio of 12.4%.

FIG. 5B is a diagram showing an example of a shot image of the developing roller's circumferential face with the actual contact area ratio of 9.4%.

FIG. 5C is a diagram showing an example of a shot image of the developing roller's circumferential face with the actual contact area ratio of 4.5%.

FIG. 6A is a graph showing a verification result of performing the experiment using a toner with a melt viscosity of 1,000,000 Pa·S at 90° C.

FIG. 6B is a graph showing a verification result of performing the experiment using a toner with a melt viscosity of 200,000 Pa·S at 90° C.

FIG. 6C is a graph showing a verification result of performing the experiment using a toner with a melt viscosity of 10,000 Pa·S at 90° C.

FIG. 7 is a diagram showing a first evaluation result.

FIG. 8 is a diagram showing the shape of a tip of a restricting blade and a contact area with the developing roller, of a developing device according to the one embodiment of the present invention.

FIG. 9 is a diagram showing how surface roughness of the restricting blade is measured.

FIG. 10 is a diagram showing a second evaluation result.

FIG. 11 is a diagram showing an operation of restricting, by the restricting blade, the amount of the developing agent to be carried on the developing roller's circumferential face.

### MODE FOR CARRYING OUT THE INVENTION

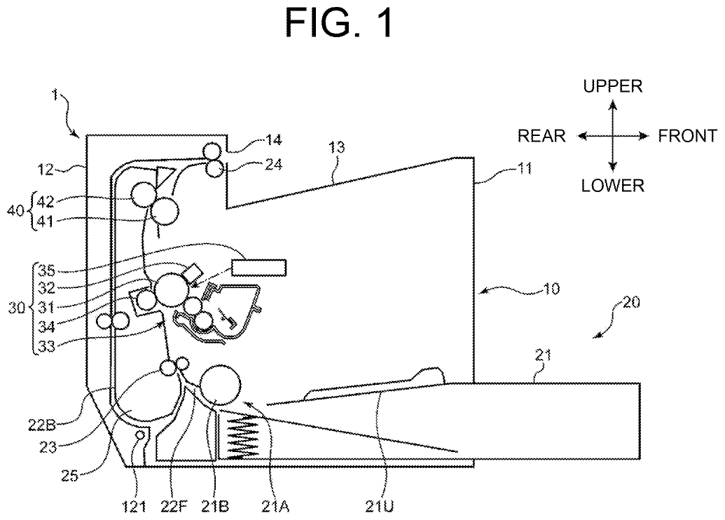

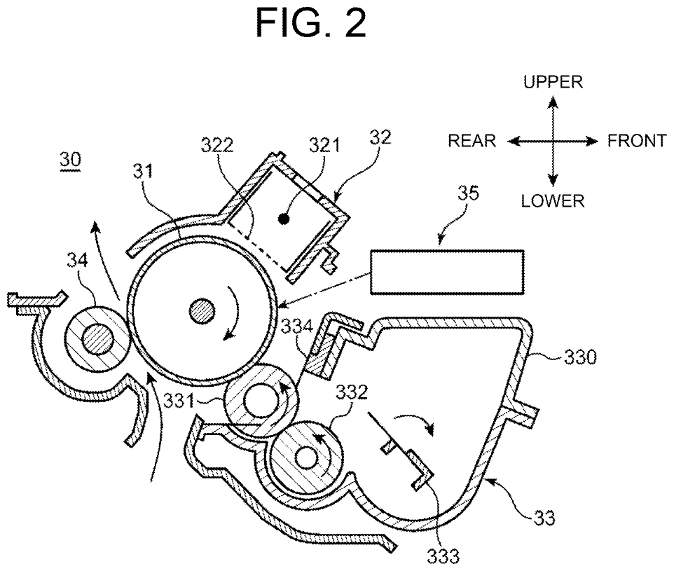

Embodiments of the present invention will be described in detail below. FIG. 1 is a cross-sectional view of an internal structure of an image forming device 1. FIG. 2 is a cross-sectional view of an image forming unit 30. In the present embodiment, the image forming device 1 shall be a monochrome printer. However, the image forming device 1 is not limited to this, but can be a copier, a facsimile machine, or a multifunction machine provided with these functions, and can also be an image forming device that forms a color image.

The image forming device 1 includes a body housing 10 having a rectangular-shaped housing structure, and a paper feed unit 20, the image forming unit 30 and a fixing unit 40 which are housed in the body housing 10. A front cover 11 and a rear cover 12 are provided on the front and rear face sides, respectively, of the body housing 10. The image forming unit 30 and the fixing unit 40 each can be inserted and removed from the rear face side of the body housing 10 by opening the rear cover 12. The upper face of the body housing 10 is provided with a paper receiving unit 13 to which sheets are discharged after the image forming. In the following description, the term “sheet” refers to copy paper, coated paper, OHP sheets, cardboard, postcards, tracing paper, and any other sheet materials that undergo an image forming process.

The paper feed unit 20 includes a paper feed cassette 21 that houses the sheets to be processed for image formation. The paper feed cassette 21 has a portion protruding further forward from the front face of the body housing 10. The upper face of the paper feed cassette 21's portion housed in the body housing 10 is covered by a paper feed cassette top plate 21U. The paper feed cassette 21 is provided with a paper storage space to store a bundle of sheets, a lift plate to lift up the bundle of sheets for feeding, and the like. A paper takeout unit 21A is provided at the upper portion on the rear end side of the paper feed cassette 21. In this paper takeout unit 21A, a paper feed roller 21B is disposed so as to take out the top layer of sheets in the sheet bundle in the paper feed cassette 21 one by one.

The image forming unit 30 performs image forming operations so as to form a toner image (developing agent image) on the sheet sent out from the paper feed unit 20. The image forming unit 30 includes a photoconductor drum 31, and a charge unit 32, an exposure unit 35, a developing unit 33 and a transfer roller 34 which are disposed around the photoconductor drum 31.

The photoconductor drum 31 is provided with a rotational axis and a circumferential face (drum circumferential face) that rotates around the rotational axis. On the photoconductor drum 31's circumferential face, an electrostatic latent image is formed and a toner image that manifests the electrostatic latent image is carried. The photoconductor drum 31 includes a known organic (OPC) photoconductor, for example, and functional layers such as a charge generation layer and a charge transporting layer are formed on the circumferential face thereof.

The charge unit 32 is disposed at a predetermined interval relative to the photoconductor drum 31's circumferential face, and, in a non-contact state, uniformly charges the photoconductor drum 31's circumferential face. Specifically, the charge unit 32 has a charge wire 321 (FIG. 2) and a grid electrode 322 (FIG. 2). The charge wire 321 is a linear electrode extending in the direction of the rotational axis of the photoconductor drum 31, and generates a corona discharge between the charge wire 321 and the photoconductor drum 31. The grid electrode 322 is a grid-shaped electrode extending in the direction of the rotational axis of the photoconductor drum 31, and is disposed between the charge wire 321 and the photoconductor drum 31. The charge unit 32 generates the corona discharge by passing a current of a predetermined value through the charge wire 321, and applies a predetermined voltage to the grid electrode 322 thereby to allow the photoconductor drum 31's circumferential face, which faces the grid electrode 322, to be uniformly charged to a predetermined aging potential.

The exposure unit 35 has a laser light source and optical system devices such as mirrors and lenses, and irradiates, onto the photoconductor drum 31's circumferential face, a light modulated based on image data given from an external device such as a personal computer. With this, on the photoconductor drum 31's circumferential face, the exposure unit 35 forms an electrostatic latent image that corresponds to the image indicated by the image data.

The developing unit 33 (developing device) is removably attached to the body housing 10, and supplies a non-magnetic single-component toner (developing agent) to the photoconductor drum 31's circumferential face thereby to develop (manifest) the electrostatic latent image formed on the photoconductor drum 31's circumferential face. Developing the electrostatic latent image means forming a toner image (developing agent image) that manifests the electrostatic latent image. Specifically, the developing unit 33 has a developing housing 330, the developing roller 331, a feed roller 332, a stirring paddle 333, and the restricting blade 334.

The developing housing 330 houses the non-magnetic single-component toner (developing agent). Specifically, based on the result of the present inventor's study, the above toner applied has a melt viscosity of 10,000 Pa·S or more to 200,000 Pa·S or less at 90° C. that is acquired when the toner is manufactured by a pulverizing method. Details of the study performed by the present inventor will be described below.

The developing roller 331 is supported by the developing housing 330 so as to be rotatable around an axis, and has a circumferential face (the first circumferential face) facing the photoconductor drum 31's circumferential face. The developing roller 331 is composed of a cylindrical member such as silicone rubber. Further, the developing roller 331's circumferential face is coated by a coating member, which has convexity and concavity, such as urethane. In the position facing the photoconductor drum 31, the developing roller 331 rotates in the direction from upstream to downstream (counterclockwise in FIG. 2) in the rotational direction (clockwise in FIG. 2) of the photoconductor drum 31. That is, when being in the position facing the photoconductor drum 31, the developing roller 331 rotates in the same direction as the photoconductor drum 31.

The feed roller 332 rotates around an axis in the developing housing 330, and has a circumferential face facing the developing roller 331's circumferential face. In the position facing the developing roller 331, the feed roller 332 rotates in the direction from downstream to upstream (counterclockwise in FIG. 2) in the rotational direction (counterclockwise in FIG. 2) of the developing roller 331. That is, in the position facing the developing roller 331, the feed roller 332 rotates in the direction opposite to the developing roller 331.

The stirring paddle 333 rotates around an axis (clockwise in FIG. 2) thereby to stir the toner inside the developing housing 330. With this, the toner in the developing housing 330 is supplied to the circumferential face of the feed roller 332 disposed in the developing housing 330.

The restricting blade 334 contacts the developing roller 331's circumferential face at a position upstream in the rotational direction of the developing roller 331 from the position where the photoconductor drum 31 and the developing roller 331 face each other. With this, the restricting blade 334 restricts the amount of the toner carried on the developing roller 331's circumferential face. Further, the restricting blade 334 rubs the toner carried on the developing roller 331's circumferential face, thereby to charge the toner. The restricting blade 334 as above has a fixed end portion that is fixed to the developing housing 330 and a free end portion that is disposed on the opposite side of the fixed end portion and contacts the developing roller 331's circumferential face (first circumferential face).

That is, the developing unit 33 rotates the developing roller 331, the feed roller 332, and the stirring paddle 333 around the axis. To the feed roller 332's circumferential face, the developing unit 33 supplies the toner stirred by the stirring paddle 333 in the developing housing 330. To and on the developing roller 331's circumferential face, the developing unit 33 supplies and carry the toner carried on the feed roller 332's circumferential face. Then, to the photoconductor drum 31's circumferential face, the developing unit 33 supplies that toner that is carried on the developing roller 331's circumferential face, charged by the restricting blade 334, and restricted in amount by the restricting blade 334.

The transfer roller 34 is a roller for transferring, onto a sheet, the toner image formed on the photoconductor drum 31's circumferential face. Specifically, the transfer roller 34 rotates around an axis, and, at a position downstream of the developing roller 331 in the rotational direction of the photoconductor drum 31, has a circumferential face facing the photoconductor drum 31's circumferential face.

To the sheet that passes through a nip portion between the transfer roller 34's circumferential face and the photoconductor drum 31's circumferential face, the transfer roller 34 transfers the toner image carried on the photoconductor drum 31's circumferential face. During this transferring, a transfer bias of opposite polarity to that of the toner is applied to the transfer roller 34.

The fixing unit 40 performs a fixing process to fix, onto the sheet, the toner image transferred to the sheet. The fixing unit 40 has a fixing roller 41 and a pressurizing roller 42. The fixing roller 41 includes a heating source, and the heating source heats the toner, which is transferred to the sheet, at a predetermined temperature. The pressurizing roller 42 is pressed against the fixing roller 41 thereby to form a fixing nip portion between the pressurizing roller 42 and the fixing roller 41. When the sheet with the toner image transferred thereto is passed through the fixing nip portion, the toner image is fixed on the sheet by heating with the fixing roller 41 and by pressing with the pressurizing roller 42.

A main conveying path 22F and a reverse conveying path 22B are provided in the body housing 10 so as to convey the sheet. The main conveying path 22F extends from the paper takeout unit 21A of the paper feed unit 20, through the image forming unit 30 and the fixing unit 40, to a paper exit port 14 provided opposite to the paper receiving unit 13 on an upper surface of the body housing 10. The reverse conveying path 22B is a conveying path for returning, when duplex printing is performed on the sheet, the single-sided printed sheet to the upstream side of the image forming unit 30 in the main conveying path 22F.

The main conveying path 22F is extended so as to pass through, from the bottom to the up, the transfer nip portion formed by the photoconductor drum 31 and the transfer roller 34. A paper stop roller pair 23 is disposed in the main conveying path 22F, upstream from the transfer nip portion. The sheet is once stopped at the paper stop roller pair 23, and after skew correction is performed, the sheet is sent out to the transfer nip portion at a predetermined timing for image transferring. A plurality of convey rollers for conveying sheets is disposed at proper locations in the main conveying path 22F and the reverse conveying path 22B. A paper exit roller pair 24 is disposed near the paper exit port 14.

The reverse conveying path 22B is formed between the outer face of the reverse unit 25 and the inner face of the rear cover 12 of the body housing 10. The transfer roller 34 and one roller of the paper stop roller pair 23 are mounted on the inner face of the reverse unit 25. The rear cover 12 and the reverse unit 25 are each be rotatable around an axis of a fulcrum unit 121 provided at lower ends thereof. When a jam (paper jam) should occur to the reverse conveying path 22B, the rear cover 12 is opened. When the jam occurs to the main conveying path 22F, or when the photoconductor drum 31's unit or the developing unit 33 is taken out to the outside, the reverse unit 25 is opened in addition to the rear cover 12.

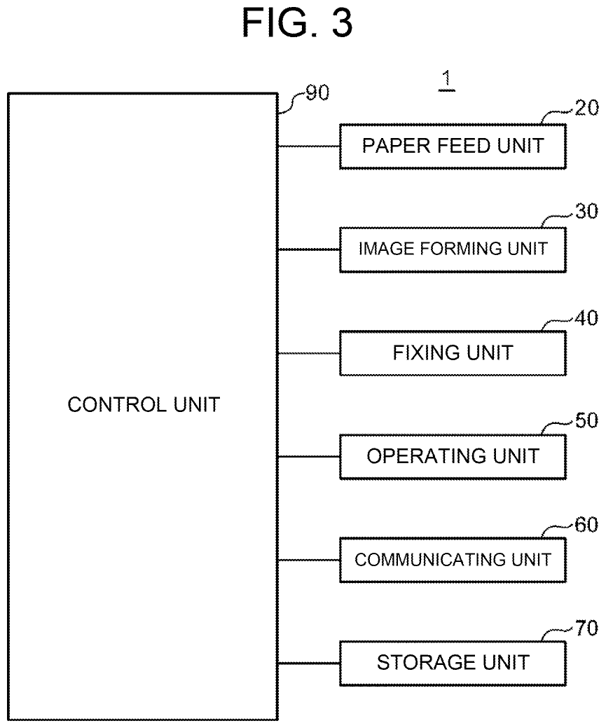

FIG. 3 is a block diagram showing an electrical configuration of the image forming device 1. As shown in FIG. 3, the image forming device 1 includes a control unit 90, an operating unit 50, a communicating unit 60, and a storage unit 70, in addition to the paper feed unit 20, the image forming unit 30, and the fixing unit 40.

The control unit 90 includes a CPU (Central Processing Unit), a ROM (Read Only Memory) which stores the control program, a RAM (Random Access Memory) which is used as the CPU's work area, and the like. To the control unit 90, the operating unit 50, the communicating unit 60, and the storage unit 70 are electrically connected, in addition to the paper feed unit 20, the image forming unit 30, and the fixing unit 40 which are described above.

The operating unit 50 is a user interface that allows a user to perform various operations of the image forming device 1. Specifically, the operating unit 50 is provided with a liquid crystal display for displaying any information on the image forming device 1, such as an operation status of the image forming device 1 (e.g., printing in progress), a touch screen for inputting any information on the operation of the image forming device 1, such as printing conditions, and various operation keys.

The communicating unit 60 is an interface circuit for realizing data communication with any external device. For example, any printing instruction and any printing-directed image data sent from an external personal computer are given to the control unit 90 via the communicating unit 60.

The storage unit 70 is a storage device such as an HDD (Hard Disk Drive) or an SSD (Solid State Drive). The storage unit 70 stores data such as the printing-directed image data that is sent from the external device such as the personal computer, for example, and given to the control unit 90 via the communicating unit 60 under the control by the control unit 90, and also stores data used to control each portion.

In the control unit 90, the CPU executes the control program, that is stored in ROM, thereby to acquire the printing instruction input by the user using the operating unit 50 or the printing instruction received by the communicating unit 60 from the external device. In accordance with the acquired printing instruction, the control unit 90 controls the image forming unit 30 and the fixing unit 40 thereby to execute the printing process of forming the image on the sheet.

The following is a detailed description of the study performed by the present inventor so as to make it possible to reduce the toner's sticking to the restricting blade 334 and to properly develop the electrostatic latent image.

In the above configuration, when a strong stress is applied to the toner at the time of restricting, by the restricting blade 334, the thickness of the toner layer formed on the developing roller 331's circumferential face, the toner may stick (fuse) to the restricting blade 334. When the toner sticks to the restricting blade 334, it is not possible to form a toner layer of uniform thickness on the developing roller 331's circumferential face, resulting in a phenomenon of a thin layer streak where the toner layer becomes locally thin on the developing roller 331's circumferential face. When the thin layer streak occur, the electrostatic latent image formed on the photoconductor drum 31's circumferential face may not be properly developed, and a white streak may be seen in the image formed on the sheet.

Then, as in the conventional art, an elastic member is attached to the restricting blade 334 thereby to reduce the stress applied to the toner by the restricting blade 334. However, in this case, the cost for configuring the restricting blade 334 is high. Further, the conventional art does not consider an area where the developing roller 331's circumferential face actually comes into contact with the elastic member. Due to this, if the area where the developing roller 331's circumferential face actually contacts the elastic member is too small, the stress applied to the toner may be reduced too much, and the toner layer formed on the developing roller 331's circumferential face may become too thick and the charge amount of the toner forming the toner layer may become too low. Meanwhile, when the contact area is too large, the toner to which the strong stress is applied by the elastic member cannot flow to a non-contact area, and the toner may stick to the elastic member too much. In these cases, the electrostatic latent image formed on the photoconductor drum 31's circumferential face is not properly developed, which may cause a problem to the image that is finally formed on the sheet.

Then, the present inventor has studied a way in which, without attaching the elastic member to the restricting blade 334, adjusting an actual contact area ratio of the developing roller 331's circumferential face and the restricting blade 334's contact linear pressure against the developing roller 331's circumferential face thereby to reduce the toner's sticking to the restricting blade 334, and also to properly develop the electrostatic latent image.

Table 1 shows an example of experimental condition.

TABLE 1

| Member | Item | Numerical value | Remark |
|---|---|---|---|
| Developing | Material | Silicone rubber + Urethane | Made by NOK |
| roller | | coating | |
| | Rubber layer thickness | 3.5 | |
| | (mm) | | |
| | External diameter (mm) | Φ13 | |
| | Shaft diameter (mm) | Φ6 | |
| | Rubber length (mm) | 232 | |
| | Line speed (mm/s) | 195 | |
| | Hardness (°) | 45 | MD-1 capa made by |
| | | | Kobunshi Keiki Co., |
| | | | Ltd. |
| | Resistance (log Ω) | 7.1 | Measure: Rotate in |
| | | | contact with metal |
| | | | roller, +100 V applied |
| Restricting blade | Material | SUS304 | |
| | Thickness (mm) | 0.1 | |
| | Free length (mm) | 10 | |
| Toner | Material | Polyester resin | |
| | Manufacturing method | Pulverization | |
| | Central particle | 6.8 | Particle size distribution |
| | diameter (μm) | | meter: LS-230 made by |
| | | | Backman Coulter |
| | Circularity | 0.96 | FPIA-3000 made by |
| | | | Sysmex Corporation |

Specifically, in the case of housing, in the developing housing 330, three types of toners with different melt viscosities at 90° C. respectively, the present inventor performed an experiment that used the developing roller 331, the restricting blade 334 and the toner which met the experimental condition shown in Table 1, varied each of the actual contact area ratio of the developing roller 331's circumferential face and the restricting blade 334's contact linear pressure against the developing roller 331's circumferential face thereby to repeat the printing processes for 200 minutes, and then performed another printing process under the same environment.

The toner amount restricted by the restricting blade 334 is adjusted depending on the restricting blade 334's contact linear pressure against the developing roller 331's circumferential face and the actual contact area ratio of the developing roller 331's circumferential face. The restricting blade 334's contact linear pressure against the developing roller 331's circumferential face is defined as the restricting blade 334's contact pressure per unit length in the contact position between the restricting blade 334 and the developing roller 331's circumferential face. The actual contact area ratio of the developing roller 331's circumferential face is defined as a ratio occupied by the area of the developing roller 331's circumferential face excluding the concave portion, relative to the area of the developing roller 331's circumferential face. That is, the actual contact area ratio of the developing roller 331's circumferential face represents an actual contact area relative to an apparent contact area between the developing roller 331's circumferential face and the restricting blade 334.

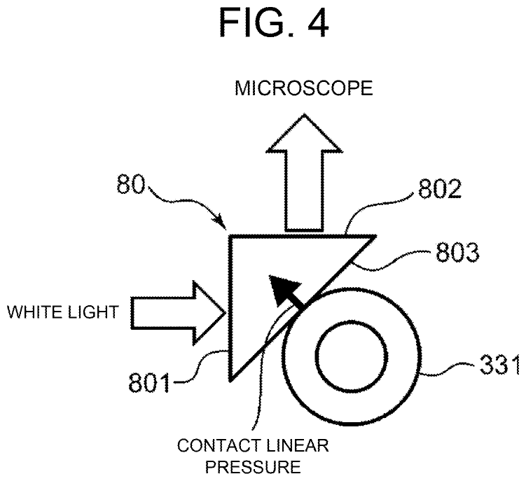

The actual contact area ratio of the developing roller 331's circumferential face can be calculated as follows. FIG. 4 is a diagram showing an example of how to calculate the actual contact area ratio. As shown in FIG. 4, it is preferable to prepare a prism 80 made of glass in the shape of a triangular prism having an outer face 801 and an outer face 802 orthogonal to each other and an outer face 803 intersecting at 45° with the outer face 801 and the outer face 802 respectively. That is, the cross section of the prism 80 is a right-angled isosceles triangle. Then, the developing roller 331 may be disposed so that the developing roller 331's circumferential face contacts the outer face 803 of the prism 80 at a contact linear pressure of 1 N/m. It is preferable that a white light is irradiated to the contact portion between the developing roller 331's circumferential face and the outer face 803 through the outer face 801 of the prism 80, thereby allowing a microscope to take the image of the contact portion between the developing roller 331's circumferential face and the outer face 803, which image is projected on the outer face 802 of the prism 80. For example, the white LED light source “IHM-25” manufactured by Leimac Ltd. can be used as the light source that emits the white light. For the microscope, the “KH-8700” manufactured by HiROX Co., Ltd. can be used.

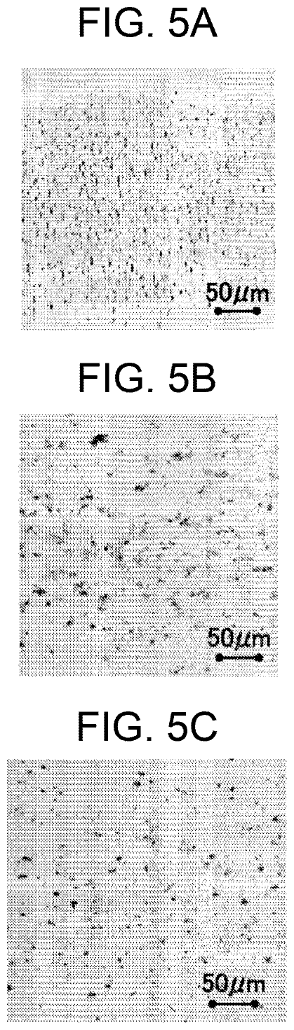

FIG. 5A, FIG. 5B, and FIG. 5C show images acquired by shooting the contact portions between the developing roller 331's circumferential faces having the actual contact area ratios of 12.4%, 9.4% and 4.5%, and the outer face 803. As shown in FIGS. 5A, 5B and 5C, a black area in the shot image, due to the developing roller 331's circumferential face and the prism 80's outer face 803 actually contacting each other, is an area where the white light irradiated through the outer face 801 of the prism 80 is absorbed. That is, the black area is considered to be an area excluding the concave portion on the developing roller 331's circumferential face. In other words, the area that is not black in the shot image is an area where the developing roller 331's circumferential face and the outer face 803 of the prism 80 are not in contact, and is considered to be the concave portion on the developing roller 331's circumferential face. Due to this, it is preferable that the above shot image is binarized, and the ratio of the black area relative to the area of the image after the binarizing process (=black area/area of image after binarizing process) may be calculated as the actual contact area ratio of the developing roller 331's circumferential face.

In the present embodiment, the restricting blade 334 is disposed so that the contact linear pressure against the developing roller 331's circumferential face is 10 N/m or more to 60 N/m or less. The developing roller 331 has the circumferential face with the actual contact area ratio of 4.5% or more to 10% or less. So as to accomplish reducing of the toner's sticking to the restricting blade 334 and a proper developing of the electrostatic latent image, the values of the contact linear pressure and the actual contact area ratio are determined based on the result of the present inventor's study.

The present inventor adopted “ECOSYSFS-140” made by Kyocera Document Solutions Inc. as the image forming device 1 used for the above experiment, replaced the developing roller 331 of the image forming device 1 according to the experiment content, and adjusted the arrangement of the restricting blade 334. The present inventor performed the above experiments with three types of toners with melt viscosities at 90° C. of 1,000,000 Pa·S, 200,000 Pa·S, and 10,000 Pa·S, respectively, housed in the developing housing 330. The present inventor has performed the above experiments in such a manner that, when the developing roller 331 with the circumferential face's actual contact area ratio of 3.3%, 4.5%, 6%, 9.4%, 10.5%, 12.4%, and 14% is mounted, the restricting blade 334 is disposed so that the restricting blade 334's contact linear pressure against the developing roller 331's circumferential face is 5 N/m, 10 N/m, 15 N/m, 20 N/m, 30 N/m, 40 N/m, 50 N/m, 60 N/m, and 70 N/m, respectively. That is, the present inventor performed the experiment in which the printing process was repeated for 200 minutes under each of 168 (=3 (the number of toner types)×7 (the number of actual contact area ratios)×8 (the number of contact linear pressures)) environments.

As shown in Table 1, the developing roller 331 made by NOK Corporation was used for the above experiment. The material of the developing roller 331 shown in Table 1 indicates that the material of the cylindrical body of the developing roller 331 is silicone rubber and the material of the coating member of the body's circumferential face is urethane. That is, the present inventor varied the number of particles of the urethane used as the coating member of the developing roller 331's circumferential face, and thereby adjusted the actual contact area ratio of the developing roller 331's circumferential face. The hardness of the developing roller 331 shown in Table 1 is measured by “MD-1capa” made by Kobunshi Keiki Co., Ltd. The resistance of the developing roller 331 shown in Table 1 is calculated from the current that flows through the developing roller 331 when the developing roller 331's circumferential face is disposed in contact with a metal roller with one end thereof grounded, and a voltage of +100 V is applied to the developing roller 331 with the developing roller 331 being rotated. The material of the restricting blade 334 shown in Table 1 is SUS304, which is also called 18Cr. 8Ni or 18-chromium stainless steel.

Then, the present inventor, in each of the initial printing process and the printing process that was performed after the 200-minute printing process, visually verified the thickness of the toner layer formed on the developing roller 331's circumferential face and the quality of the image formed on the sheet. Then, the present inventor developed a graph by plotting the verification result on a two-dimensional coordinate where the abscissa is the actual contact area ratio of the developing roller 331's circumferential face and the ordinate is the restricting blade 334's contact linear pressure against the developing roller 331's circumferential face.

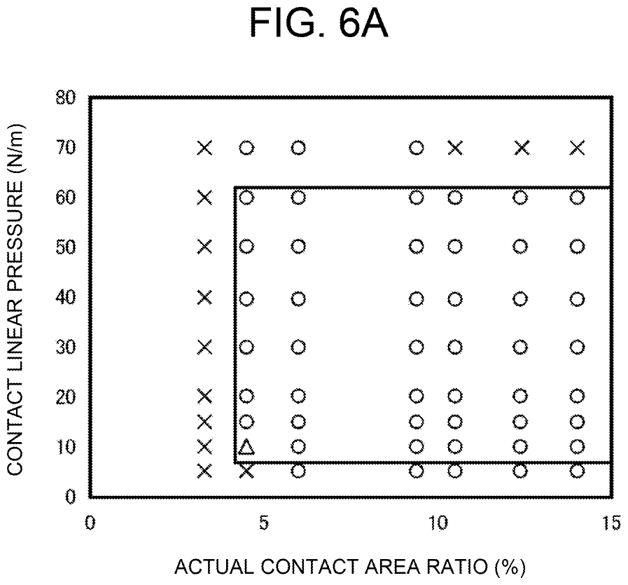

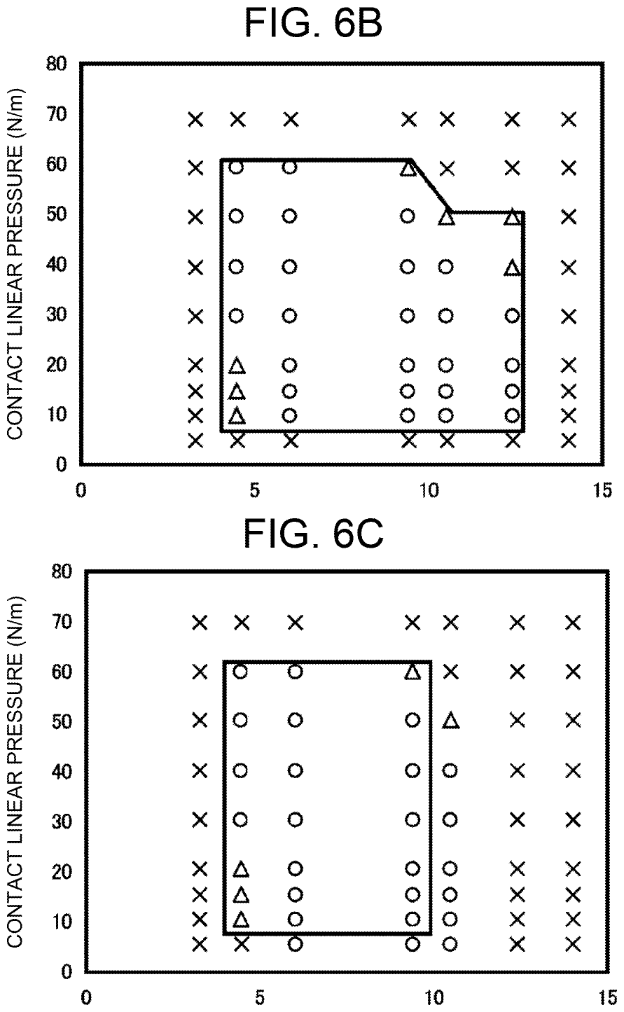

FIG. 6A is a graph showing the verification result of performing the experiment using a toner with a melt viscosity of 1,000,000 Pa·S at 90° C. FIG. 6B is a graph showing the verification result of performing the experiment using a toner with a melt viscosity of 200,000 Pa·S at 90° C. FIG. 6C is a graph showing the verification result of performing the experiment using a toner with a melt viscosity of 10,000 Pa·S at 90° C.

In FIGS. 6A to 6C, ∘, Δ, and x show the results of the present inventor's visually verifying the thickness of the toner layer formed on the developing roller 331's circumferential face and the quality of the image formed on the sheet, in each of the initial printing process and the printing process that was performed after the 200-minute printing process. Specifically, ∘ indicates that in any of the above two printing processes, the toner layer formed on the developing roller 331's circumferential face was uniform, and the quality of the image formed on the sheet was in a normal state with no problem. Δ indicates that, in at least one of the above two printing processes, the toner layer formed on the developing roller 331's circumferential face had a minor thin layer streak, or the toner layer formed on the developing roller 331's circumferential face had an uneven thickness, but in any of the above two printing processes, the quality of the image formed on the sheet had no problem for practical use. x indicates that, in any of the above two printing processes, the toner layer formed on the developing roller 331's circumferential face showed a minor thin layer streak, or the toner layer formed on the developing roller 331's circumferential face showed an uneven thickness, and the image formed on the sheet also showed abnormalities such as white streak and uneven density, indicating that the condition was problematic for practical use.

From the verification result shown in FIG. 6A, the present inventor has found that, when the toner with the melt viscosity of 1,000,000 Pa·S at 90° C. is used, the actual contact area ratio of the developing roller 331's circumferential face being 4.5% and the restricting blade 334's contact linear pressure against the developing roller 331's circumferential face being 10 N/m or more can form, on the sheet, an image with a quality having no practical problem. However, at the time of verifying the image formed on the sheet in the present experiment, the present inventor has found that the sheet was contaminated. This evaluates that the fixing unit 40 of the image forming device 1 used for the present experiment cannot properly fix, to the sheet, the toner with the melt viscosity of 1,000,000 Pa·S at 90° C., and that the toner has a problem in fixing property for practical use.

From the verification result shown in FIG. 6B, the present inventor has found that, when the toner with the melt viscosity of 200,000 Pa·S at 90° C. is used, the actual contact area ratio of the developing roller 331's circumferential face being 4.5% or more to 12.4% or less and the restricting blade 334's contact linear pressure against the developing roller 331's circumferential face being 10 N/m or more to 50 N/m or less can form, on the sheet, an image with a quality having no practical problem. Further, from the verification result shown in FIG. 6B, the present inventor has found that when the toner with the melt viscosity of 200,000 Pa·S at 90° C. is used, the actual contact area ratio of the developing roller 331's circumferential face being 4.5% or more to 10% or less, despite the restricting blade 334's contact linear pressure against the developing roller 331's circumferential face being 50 N/m or more to 60 N/m or less, can form, on the sheet, an image with a quality having no practical problem. At the time of verifying the image formed on the sheet in the present experiment, the present inventor has found no contaminant on the sheet. This evaluates that the fixing unit 40 of the image forming device 1 used for the present experiment can properly fix, onto the sheet, the toner with a melt viscosity of 200,000 Pa·S at 90° C., and that the toner has no problem for practical use.

From the verification result shown in FIG. 6C, the present inventor has found that when the toner with the melt viscosity of 10,000 Pa·S lower than 200,000 Pa·S at 90° C. is used, the actual contact area ratio of the developing roller 331's circumferential face being 4.5% or more to 10% or less and the restricting blade 334's contact linear pressure against the developing roller 331's circumferential face being 10 N/m or more to 60 N/m or less can form, on the sheet, an image with no practical problem. At the time of verifying the image formed on the sheet in the present experiment, the present inventor has found no contaminant on the sheet. This evaluates that the fixing unit 40 of the image forming device 1 used for the present experiment can properly fix, to the sheet, the toner with the melt viscosity of 10,000 Pa·S at 90° C., and that the toner has no problem in fixing property for practical use.

Further, the present inventor compared the verification results shown in FIGS. 6B and 6C, and has found that when the toner with the melt viscosity of 10,000 Pa·S or more to 200,000 Pa·S or less at 90° C. is used, the lower the toner's melt viscosity, i.e., the higher the toner's flowability, the narrower the range of the actual contact area ratio of the developing roller 331's circumferential face and the range of the restricting blade 334's contact linear pressure against the developing roller 331's circumferential face, which are for making it possible to form, on the sheet, the image with a quality having no practical problem. The present inventor has also found that, the actual contact area ratio of the developing roller 331's circumferential face being 4.5% or more to 10% or less and the restricting blade 334's contact linear pressure against the developing roller 331's circumferential face being 10 N/m or more to 60 N/m or less, even when the toner with the melt viscosity of 10,000 Pa·S or more to 200,000 Pa·S or less at 90° C. is used, can form, on the sheet, an image with a quality having no practical problem, causing no problem to the toner's fixing property.

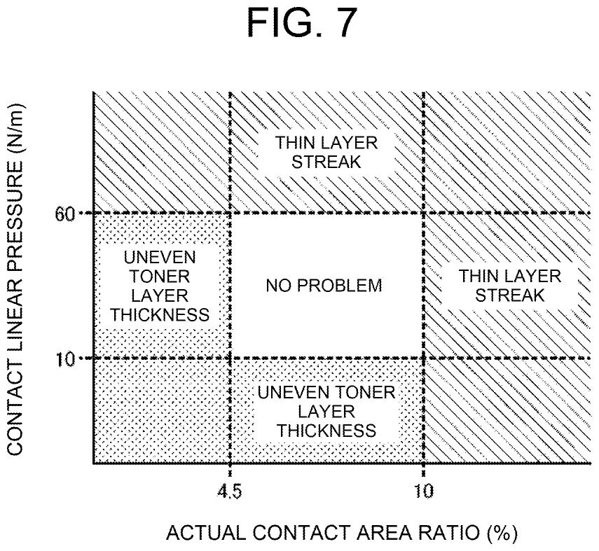

FIG. 7 is a diagram showing a first evaluation result. As described above, from the verification results shown in FIGS. 6A to 6C, the present inventor has found that when the toner with the melt viscosity of 10,000 Pa·S or more to 200,000 Pa·S or less at 90° C. which causes no problem to the fixing property, as shown in FIG. 7, the actual contact area ratio of the developing roller 331's circumferential face being 4.5% or more to 10% or less and the restricting blade 334's contact linear pressure against the developing roller 331's circumferential face being 10 N/m or more to 60 N/m or less can reduce the possibility of the toner sticking to the restricting blade 334, and can properly develop the electrostatic latent image, thus causing no problem to the image formed on the sheet.

Further, the present inventor has found that when the toner with the melt viscosity of 10,000 Pa·s or more to 200,000 Pa·s or less at 90° C. is used, as shown in FIG. 7, despite the restricting blade 334's contact linear pressure against the developing roller 331's circumferential face being 60 N/m or less, the actual contact area ratio of the developing roller 331's circumferential face being more than 10% causes a thin layer streak to the toner layer on the developing roller 331's circumferential face. This may be for the following reason.

When the toner layer on the developing roller 331's circumferential face is restricted by the restricting blade 334, the toner underneath the restricting blade 334 is moved to the concave portion of the developing roller 331's circumferential face and carried thereon. Due to this, the larger the actual contact area ratio of the developing roller 331's circumferential face, the fewer the concave portions as a destination of the toner under the restricting blade 334, thus increasing the stress applied to the toner. With this, it is deemed that the larger the actual contact area ratio of the developing roller 331's circumferential face, the more the amount of the toner sticking to the restricting blade 334, thus making it easier to cause the thin layer streak to the toner layer on the developing roller 331's circumferential face.

Meanwhile, the present inventor has found that when the toner with the melt viscosity of 10,000 Pa·S or more to 200,000 Pa·S or less at 90° C. is used, as shown in FIG. 7, despite the restricting blade 334's contact linear pressure against the developing roller 331's circumferential face being 60 N/m or less, the developing roller 331's circumferential face having the actual contact area ratio of less than 4.5% causes unevenness to the thickness of the toner layer on the developing roller 331's circumferential face. Further, the present inventor has found that when the toner with the melt viscosity of 10,000 Pa·S or more to 200,000 Pa·S at 90° C. is used, as shown in FIG. 7, the restricting blade 334's contact linear pressure against the developing roller 331's circumferential face being 10 N/m or less, despite the actual contact area ratio of the developing roller 331's circumferential face being 4.5% or more to 10% or less, causes unevenness to the thickness of the toner layer on the developing roller 331's circumferential face. It is deemed that these are for the following reason.

The smaller the actual contact area ratio of the developing roller 331's circumferential face, the more the concave portions are on the developing roller 331's circumferential face, thus making it easier for the toner, to which the stress is applied by the restricting blade 334, to flow between the concave portions. This means that the smaller the actual contact area ratio of the developing roller 331's circumferential face, the more likely it is that the thickness of the toner layer on the developing roller 331's circumferential face will be uneven. Further, it is deemed that, the restricting blade 334's contact linear pressure against the developing roller 331's circumferential face being 10 N/m or less excessively reduces the stress applied by the restricting blade 334 to the toner; therefore, the smaller the actual contact area ratio of the developing roller 331's circumferential face, the easier it is for the toner to flow between the concave portions on the developing roller 331's circumferential face, thus the more likely it is that the thickness of the toner layer on the developing roller 331's circumferential face will be uneven.

Further, from the verification results shown in FIGS. 6B and 6C, the present inventor has found that when the toner with the viscosity of 10,000 Pas or more to 200,000 Pa·s or less at 90° C. is used, and the restricting blade 334's contact linear pressure against the developing roller 331's circumferential face is 10 N/m or more to 60 N/m or less, it is more preferable to set the actual contact area ratio of the developing roller 331's circumferential face between 6% and 9%, in order to make the toner layer formed on the developing roller 331's circumferential face uniform and not to cause any problem to the quality of the image formed on the sheet.

Further, from the verification results shown in FIGS. 6B and 6C, the present inventor has found that when the toner with the melt viscosity of 10,000 Pa·S or more to 200,000 Pa·S at 90° C. is used, and when the actual contact area ratio of the developing roller 331's circumferential face is 4.5% or more to 10% or less, it is more preferable to set the restricting blade 334's contact linear pressure against the developing roller 331's circumferential face to 30 N/m or more to 50 N/m or less, in order to make uniform the toner layer formed on the circumferential face of the developing roller 331 and not to cause any problem to the quality of the image formed on the sheet.

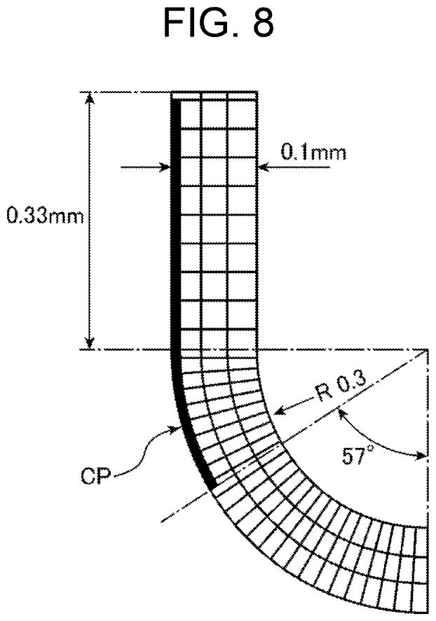

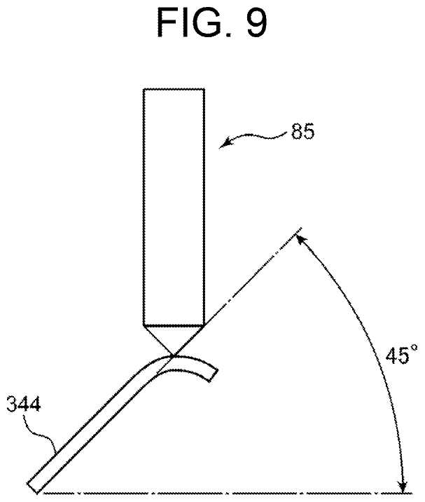

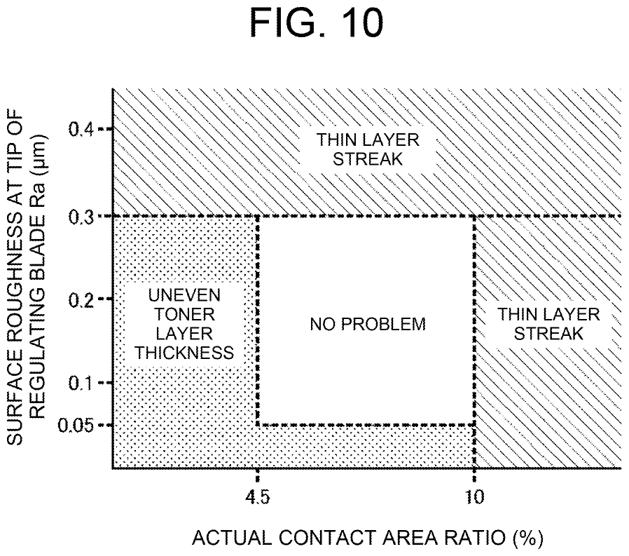

Further, as a result of further study, the present inventor has newly found that the surface roughness of the portion where the restricting blade 334 contacts the developing roller 331 is related to whether or not the thin layer streak occurs. FIG. 8 is a diagram showing the shape of a tip (free end portion) of the restricting blade 334 and the contact area with the developing roller 331, of the developing unit 33 according to the present embodiment. FIG. 9 is a diagram showing how the surface roughness of the restricting blade 334 is measured. FIG. 10 is a diagram showing a second evaluation result.

Referring to FIG. 8, while the fixed end portion of the restricting blade 334 is supported by the developing housing 330 as shown in FIG. 2, the free end portion (tip portion) of the restricting blade 334 includes a bent portion (curved face) that, when viewed from the axial direction of the developing roller 331, has a curvature radius of 0.3 mm and is bent away from the developing roller 331. The bent portion is formed by bending (R-bending) the tip portion of a base material of the restricting blade 334 having a straight shape. Further, in the developing unit 33, as a result of a nonlinear analysis of the restricting blade 334's state of contacting the developing roller 331, it has been verified that, as shown in an area CP (contact area) in FIG. 8, the developing roller 331's circumferential face also contacts the bent portion at the tip of the restricting blade 334. In the restricting blade 334, the portion where the bending is done at the tip is higher in surface roughness, due to a processed strain, than the portion where the bending is not done on the base end side. Therefore, experimentally, including the bent portion of the tip above, in order to make the surface roughness of the restricting blade 334 finer, it is necessary to perform a pulverizing process including the bent portion of the tip. Then, in the present embodiment, buffing has been adopted as an example of the pulverizing process for the restricting blade 334.

Polishing the surface of the restricting blade 334 by the buffing and measuring the surface roughness thereof have made samples different in surface roughness from each other. As shown in FIG. 9, regarding the surface roughness of the restricting blade 334, a jig (not shown) that can fix the restricting blade 334 at an angle of 45 degrees relative to the horizontal face was prepared so that the surface roughness of the bent portion at the tip in contact with the developing roller 331 can be measured by a measuring needle 85. Then, the S-3100 made by Mitutoyo was used as a measuring instrument so as to measure the surface roughness of the restricting blade 334. Measurement conditions in this case were JIS standard 2001, measurement length 4.8 mm, cutoff 0.8 mm, measurement speed 0.5 mm/sec.

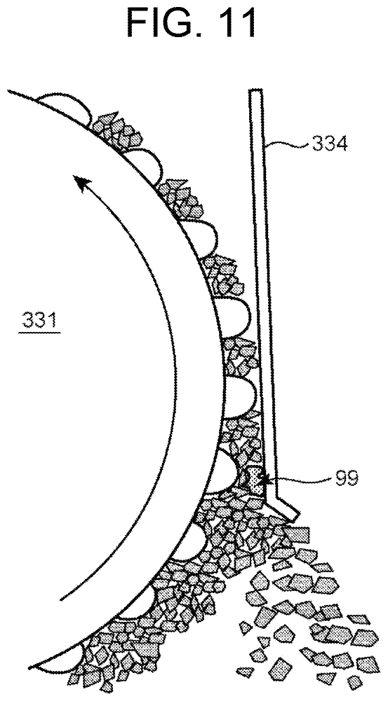

Based on the above preliminary study, a sample was prepared in which the surface roughness of the tip portion of the restricting blade 334 (especially, an area that includes the above bent portion and contacts the developing roller 331's circumferential face) was varied, then, the restricting blade 334's contact linear pressure against the developing roller 331's circumferential face was set in the range of 10 N/m or more to 60 N/m or less, then as a result of the same evaluation as the first evaluation result, as shown in FIG. 11, it has been verified that the surface roughness (Ra) of the contact area CP where the restricting blade 334 contacts the developing roller 331 affects whether or not the thin layer streak occurs.

As shown in FIG. 11, when the surface roughness Ra of the tip portion of the restricting blade 334 is 0.05 or more to 0.3 μm or less, no problem arises in terms of the thin layer streak and unevenness of toner layer thickness. It has been found that, when the above surface roughness Ra exceeds 0.3 μm, the thin layer streak occurs, and when the surface roughness is less than 0.05 μm, unevenness in the thin toner layer (uneven toner layer thickness) occurs. The same effect as above has been acquired in the range where the curvature radius of the bent portion of the tip portion of the restricting blade 334 is 0.1 mm or more.

The present inventor has verified that, even when the actual contact area ratio of the developing roller 331's circumferential face is adjusted depending on the degree of polishing the developing roller 331's circumferential face without coating the developing roller 331's circumferential face with a member separate from the body, the same finding as above can be acquired.

In the experimental condition shown in Table 1, the central particle diameter of the toner was set to 6.8 μm; however, the present inventor performed the same experiment as above with the central particle diameter of the toner between 6.0 μm or more to 8.0 μm or less, and have verified that the same finding as above can be acquired. With the central particle diameter of the toner less than 6.0 μm, the production cost of the toner will be high, and with the central particle diameter of the toner larger than 8.0 μm, the consumption of the toner will increase and the fixing property on the sheet will deteriorate. Due to this, the present inventor performed the experiment only for the case where the central particle diameter of the toner is 6.0 μm or more to 8.0 μm or less.

In the experimental condition shown in Table 1, the circularity of the toner was set to 0.96; however, the present inventor also performed the same experiment as above with the toner circularity of 0.93 or more to 0.97 or less, and verified that the same finding as above can be acquired. With the circularity of the toner less than 0.93, the quality of the image formed on the sheet will deteriorate, and with the circularity of the toner more than 0.97, the production cost of the toner will be significantly higher. Due to this, the present inventor performed the experiment only for the case where the toner circularity is 0.93 or more to 0.97 or less.

In the experimental condition shown in Table 1, the hardness of the developing roller 331 was measured by “MD-1capa” made by Kobunshi Keiki Co., Ltd., and was set to 45°. However, the present inventor measured the hardness of the developing roller 331 by the same method, and with the developing roller 331's hardness measured being 40° or more to 60° or less, also performed the same experiment as above, thereby to verify that the same finding as above can be acquired. With the hardness of the developing roller 331 less than 40°, a pressure mark due to a permanent deformation is left on the photoconductor drum 31's circumferential face and the restricting blade 334, causing a problem to the quality of the image formed on the sheet. Meanwhile, with the hardness of the developing roller 331 more than 60°, the stress applied to the toner rapidly increases, thus rapidly increasing the probability of the thin layer streak occurring to the developing roller 331's circumferential face. Due to this, the present inventor performed the experiment only for the case where the hardness of the developing roller 331 is 40° or more to 60° or less.

Further, the present inventor also performed the same experiment as above when the melt viscosity at 90° C. of the toner housed in the developing housing 330 is more than 200,000 Pa·S to 250,000 Pa·S or less, and has verified that the same finding as above can be acquired. As a result of the above experiment using the toner with the melt viscosity of more than 250,000 Pa·S at 90° C., contaminant appeared on the sheet as in the experiment using the toner with the melt viscosity of 1,000,000 Pa·S at 90° C. described above, and the toner did not fix well to the sheet. Due to this, the present inventor has evaluated that the toner with the melt viscosity more than 250,000 Pa·S at 90° C. causes a practical problem.

The present inventor has also evaluated, as follows, the adopting of the toner manufactured by the pulverizing method. Compared with the particle of the toner manufactured by the polymerizing method, the particle of the toner manufactured by the pulverizing method is less expensive to manufacture, but has lower circularity. Therefore, when the strong stress is applied by the restricting blade 334, compared with the particle of the toner manufactured by the polymerizing method, the particle of the toner manufactured by the pulverizing method is more likely to be caught by the restricting blade 334, and is also more likely to stick due to the mating of concave and convex portions of adjacent particles. Due to this, compared with the toner manufactured by the polymerizing method, the toner manufactured by the pulverizing method is more likely to stick to the restricting blade 334, and is more likely to cause an unevenness to the thickness of the toner layer formed on the developing roller 331's circumferential face.

However, even if the toner manufactured by the pulverizing method is adopted as described above, the actual contact area ratio of the developing roller 331's circumferential face being 4.5% or more to 10% or less or less and the restricting blade 334's contact linear pressure against the developing roller 331's circumferential face being 10 N/m or more to 60 N/m or less, when the amount of the toner carried on the developing roller 331's circumferential face is restricted by the restricting blade 334, can reduce the possibility of the toner sticking to the restricting blade 334, and can suppress unevenness from occurring to the thickness of the toner layer. Due to this, applying, to the image forming device 1, the toner manufactured by the pulverizing method, which toner is less expensive than the toner manufactured by the polymerizing method, can reduce the cost of using the image forming device 1 while maintaining the quality of the image finally formed.

In the above embodiment, the example of adopting the toner manufactured by the pulverizing method has been described, but the toner manufactured by the polymerizing method may also be adopted. Suppose that the image forming device is so configured as to eliminate the poor fixing property of the toner that has a high melt viscosity and is fixed to the sheet, for example, by equipping the fixing roller 41 capable of melting, at a high temperature, the toner with high melt viscosity. In the present image forming device, the toner's melt viscosity at 90° C. and the restricting blade 334's contact linear pressure against the developing roller 331's circumferential face are arbitrary, and the developing roller 331 having the circumferential face's actual contact area ratio of 4.5% or more to 10% or less may be adopted.

The present inventor performed the same experiment as above with these image forming devices as well, and as a result of performing a similar verification to the above, acquired substantially the same verification result as the verification result shown in FIG. 7A. That is, the present inventor has found that, regardless of the toner's melt viscosity at 90° C. and the restricting blade 334's contact linear pressure against the developing roller 331's circumferential face, when the actual contact area ratio of the developing roller 331's circumferential face is 4.5% or more to 10% or less, the toner layer formed on the developing roller 331's circumferential face is uniform, causing no problem to the quality of the image formed on the sheet.

### DESCRIPTION OF REFERENCE NUMERALS

1: image forming device
31: photoconductor drum
33: developing unit
331: developing roller
334: restricting blade

1. An image forming device that performs developing using a non-magnetic single-component developing agent, comprising:
a photoconductor drum that rotates around an axis and has a drum circumferential face on which an electrostatic latent image is formed; and
a developing unit that supplies the developing agent to the photoconductor drum thereby to manifest the electrostatic latent image into a developing agent image;
wherein
the developing unit includes:
a developing housing that houses the developing agent,
a developing roller that is supported by the developing housing in a manner to be rotatable around an axis, has a first circumferential face that faces the drum circumferential face and carries the developing agent, and supplies the carried developing agent to the drum circumferential face, and
a restricting blade that contacts the first circumferential face, and restricts an amount of the developing agent to be carried on the first circumferential face, and
wherein
the first circumferential face has a value of 4.5% or more to 10% or less as an actual contact area ratio that represents an actual contact area relative to an apparent contact area with the restricting blade, and the restricting blade is arranged relative to the first circumferential face at a contact linear pressure of 10 N/m or more to 60 N/m or less at the actual contact area ratio.

2. The image forming device according to claim 1, wherein
the restricting blade is supported by the developing housing such that the contact linear pressure against the first circumferential face is in a range of 10 N/m or more to 60 N/m or less.

3. The image forming device according to claim 2, wherein
the restricting blade has a fixed end portion fixed to the developing housing and a free end portion disposed on an opposite side of the fixed end portion and contacts the first circumferential face of the developing roller, and
the free end portion includes a bent portion having a bent shape that is away from the developing roller, and a curvature radius of the bent portion is 0.1 mm or more.

4. The image forming device according to claim 3, wherein
the restricting blade contacts the circumferential face of the developing roller in an area including at least a part of the bent portion, and a surface roughness Ra of the area is included in a range of 0.05 μm or more to 0.3 μm or less.

5. The image forming device according to claim 1, wherein
the developing agent is manufactured by a pulverizing method or a polymerizing method, and has a circularity of 0.93 or more to 0.97 or less, or a central particle diameter of 6.0 μm or more to 8.0 μm or less.

6. The image forming device according to claim 1, wherein
a melt viscosity of the developing agent at 90° C. is included in a range of 10,000 Pa·S or more to 200,000 Pa·S or less.
